(19) United States
(12) Patent Application Publication
(10) Pub. No.: US 2017/0269376 A1
(43) Pub. Date: Sep. 21, 2017

(54) HEAD-WORN AUTOMATIC FLIPPING EYEWEAR

(71) Applicant: Dongguang LIU, Guangdong (CN)

(72) Inventor: Dongguang LIU, Guangdong (CN)

(21) Appl. No.: 15/616,949

(22) Filed: Jun. 8, 2017

Related U.S. Application Data
(63) Continuation of application No. PCT/CN2015/083387, filed on Jul. 6, 2015.

(30) Foreign Application Priority Data
Apr. 13, 2015 (CN) 201510173744.8

(51) Int. Cl. G02C 3/02; G02C 9/02; G02C 7/08

(52) U.S. Cl. CPC G02C 3/02; G02C 7/08; G02C 9/02; G02C 2202/24

(57) ABSTRACT

A head-worn automatic flipping eyewear comprises a housing (1), front automatic flipping lenses (2), rear fixed lenses (3), a transmission system, a circuit control system and a head fixing piece (7). The front automatic flipping lenses (2) are rotatably connected to the housing (1), and the rear fixed lenses (3) are fixedly connected to the housing (1), wherein the front automatic flipping lenses (2) are located in front of the rear fixed lenses (3). The transmission system and the circuit control system are located in the housing (1), and the head fixing piece (7) is located on the housing (1), wherein the circuit control system controls operations of the transmission system, and the transmission system controls flipping of the front automatic flipping lenses (2). The head-worn automatic flipping eyewear can be worn on the head for training, and the lenses are automatically flipped up or down, such that holding the lenses with a hand or manually flipping the lenses is unnecessary. Thereby, integration of the training via lens flipping with reading and writing is facilitated, and long-term persistent training can be achieved to obtain a good result.

### BACKGROUND OF THE INVENTION

The present invention relates generally to the field of eye care, and more particularly to head wear type automatic flip glasses.

In China, more and more people are suffering from myopia, and patients tend to become younger and younger. Owing to the fact that myopia has caused great inconvenience for people's daily life, many eye-care devices have been invented in order to improve people's eyesight. Among those devices, flipping lenses are one of the simplest and most effective ones. It consists of four butterfly-shaped lenses scattering around two sides of a shaft, with two positive lenses on one side and two negative lenses of the same degree on the other. When the shaft is flipped, the positive lenses and the negative lenses will be exchanged. During that process, the user's eyes are forced to switch between accommodation and relaxation. And the switch is helpful to improve the speed of accommodation, increase the amplitude of accommodation, speed up reading rate, upgrade visual clarity, make eyes more comfortable, and prevent myopia, vision degeneration and asthenopia caused by lag of accommodation and insufficient accommodation.

However, currently available flipping lenses, no matter manufactured at home or abroad, have the following limitations:

1. Flipping lenses are all hand-held type. Users are required to hold them in front of their eyes. Therefore, it's labor-consuming.

2. No timing function. Users are required to flip at a frequency of 8 to 20 times per minute. Meanwhile, they should keep their eyes focusing on the E mark which is 40 cm away. Because of the inconvenience, few students can persist in such training. Therefore the effects are undesirable.

3. Due to different flipping frequencies caused by manual operation, the training effects vary among different users. Uniform training effects can hardly be achieved.

### BRIEF SUMMARY OF THE INVENTION

For those reasons mentioned above, it is necessary to provide head wear type automatic flip glasses.

Head wear type automatic flip glasses include a housing, front automatic flipping lenses, rear fixing lenses, a transmission system, a circuit control system and a head fixing member. The front automatic flipping lenses are connected with the housing in a flipping manner, whereas the rear fixing lenses are in fixed connection with the housing. The front automatic flipping lenses are located in front of the rear fixing lenses. The transmission system and the circuit control system are located in the housing. The head fixing member is located on the housing. The transmission system is driven by the circuit control system. And the transmission system is used for controlling the front automatic flipping lenses to flip.

Optimally, the housing includes a front housing and a rear housing; the front automatic flipping lenses are connected with the front housing or rear housing in a flipping manner; and the rear fixing lenses are in fixed connection with the rear housing.

More optimally, the front automatic flipping lenses are connected with the front housing or the rear housing in a flipping manner through a flipping structure. The flipping structure includes a fixing clamp and a fixing sleeve. The fixing clamp includes two side boards with through-holes. The fixing sleeve has a central hole at the middle part. The fixing sleeve is located between the two side boards of the fixing clamp. The central hole corresponds to the through-holes of the side boards. The fixing clamp is located on the front housing or the rear housing. And the fixing sleeve is located on the flipping lens frame of the front automatic flipping lenses.

Further optimally, the rear housing includes a rear-housing middle-transverse portion. There are two flipping structures, with one being two fixing sleeves configured on the left and right frame of the front automatic flipping lenses respectively, and the other being two corresponding fixing clamps disposed on the rear-housing middle-transverse portion.

More optimally, the rear housing includes a rear-housing middle-transverse portion. The upper part of the flipping lens frame of the rear fixing lenses is the lower edge of the rear-housing middle-transverse portion, or the upper part of the flipping lens frame of the rear fixing lenses is fixed at the lower edge of the rear-housing middle-transverse portion.

Optimally, the transmission system is comprised of a worm gear, a helical gear, a short iron shaft, a forced-braking protection structure and a long iron shaft. The worm gear is meshed with the helical gear. The central hole of the helical gear is connected with one end of the short iron shaft, while the other end of the short iron shaft is connected with the long iron shaft through the forced-braking protection structure. And the long iron shaft is connected with the flipping structure. With regard to the forced-braking protection structure, it is an elastic pipe or a clutch device.

More optimally, the elastic pipe is a silica gel pipe or a rubber pipe, and the clutch device is a spring clip.

Optimally, the circuit control system is composed of a motor, a circuit control PCB and a battery. The motor is connected with the transmission system. The circuit control PCB controls the rotation of the motor. And the battery supplies power to the circuit control PCB. There is a functional chip on the circuit control PCB. And the functional chip consists of a timing module and/or a flipping frequency adjusting module.

Optimally, the circuit control PCB is provided with at least one of a charging plug, a charging protection circuit, a motor driving IC, a power button and an indicator light.

Optimally, a hollow cavity formed by the front housing and the rear housing includes a middle cavity and two lateral cavities. The circuit control PCB is located in the middle cavity, namely between the front-housing middle-transverse portion and the rear-housing middle-transverse portion; while the transmission system and the motor are located in one lateral cavity, and the battery is located in the other.

Optimally, the degrees of the front automatic flipping lenses and the rear fixing lenses depend on the myopia degree of the wearer and the selected adjustment training strength/amplitude. The algorithm is as follows:

degree of the front automatic flipping lenses=myopia degree of the wearer+(−X),

degree of the rear fixing lenses=myopia degree of the wearer+(+X),

X is the selected adjustment training strength/amplitude which ranges from 0.5D, 1.0D, 1.5D, 2.0D, and 2.5D to 3.0D.

Optimally, the rear fixing flipping lens frame is provided with a nose support. And the back face of the rear housing is provided with a sponge mat.

Optimally, the head fixing member is an elastic cord or tie ropes.

More optimally, the left and right sides of the front housing or rear housing are provided with a retaining ring respectively. Two bent hooks are provided respectively on both ends of the elastic cord, with one being fixed at one retaining ring, the other being in detachable connection with the other retaining ring. Two tie ropes are provided, and the left and right sides of the front housing or rear housing respectively fixes one end of one of the tie ropes.

Optimally, the housing is n-shaped, and the front automatic flipping lenses and the rear fixing lenses are located in the n-shaped housing.

Compared with the currently available technologies, the head wear type automatic flip glasses of the present invention has the following beneficial effects:

1. The head wear type automatic flip glasses of the present invention looks more like normal glasses, and can be worn on the head to perform training. The front automatic flipping lenses flip automatically. So there's no need for hand-holding or manual flipping. That contributes to the integration of the flip training with reading and writing. Hence, it's more helpful for persistent training, which can predict better training effects.

2. The head wear type automatic flip glasses of the present invention can be used for amblyopia treatment, vision improvement training, and myopia prevention. It can improve the visual sensitivity significantly and can prevent and control myopia, which may be caused in amblyopia treatment effectively.

3. The head wear type automatic flip glasses of the present invention are provided with a flipping frequency adjusting module. Users can adjust the flipping frequency according to their own needs. And it is also provided with a timing module which can be used to set the training duration. So there's no need for users to time the training. It's more user-friendly.

### BRIEF DESCRIPTION OF THE DRAWINGS

FIG. 1 is an exploded structural view of the head wear type automatic flip glasses of the present invention.

FIG. 2 is a front view of the head wear type automatic flip glasses of the present invention.

FIG. 3 is a cross-sectional view of FIG. 3 in A-A direction.

FIG. 4 is a cross-sectional view of FIG. 3 in B-B direction.

FIG. 5 is a rear view of the head wear type automatic flip glasses of the present invention.

FIG. 6 is a structural view of a circuit control PCB.

Marks in Figures: 1. housing; 2. front automatic flipping lenses; 3. rear fixing lenses; 11. front housing; 12. rear housing; 111. decorative strip; 112. decorative strip slot; 121. rear-housing middle-transverse portion; 21. front automatic flipping lens frame; 22 front flipping lenses; 23. cushion; 31. rear fixing flipping lens frame; 32. rear flipping lenses; 41. worm gear; 42. helical gear; 43. short iron shaft; 44. forced-braking protection structure; 45. long iron shaft; 51. motor; 52. circuit control PCB; 53. battery; 521. functional chip; 522. charging plug; 523. motor drive IC; 524. power button; 525. indicator light; 61. fixing clamp; 62. fixing sleeve; 7. tie rope; 81. nose support; 82. sponge mat.

### DETAILED DESCRIPTION OF THE INVENTION

In order to explain the present invention better, further illustrations together with Figures and embodiments will be provided as follows.

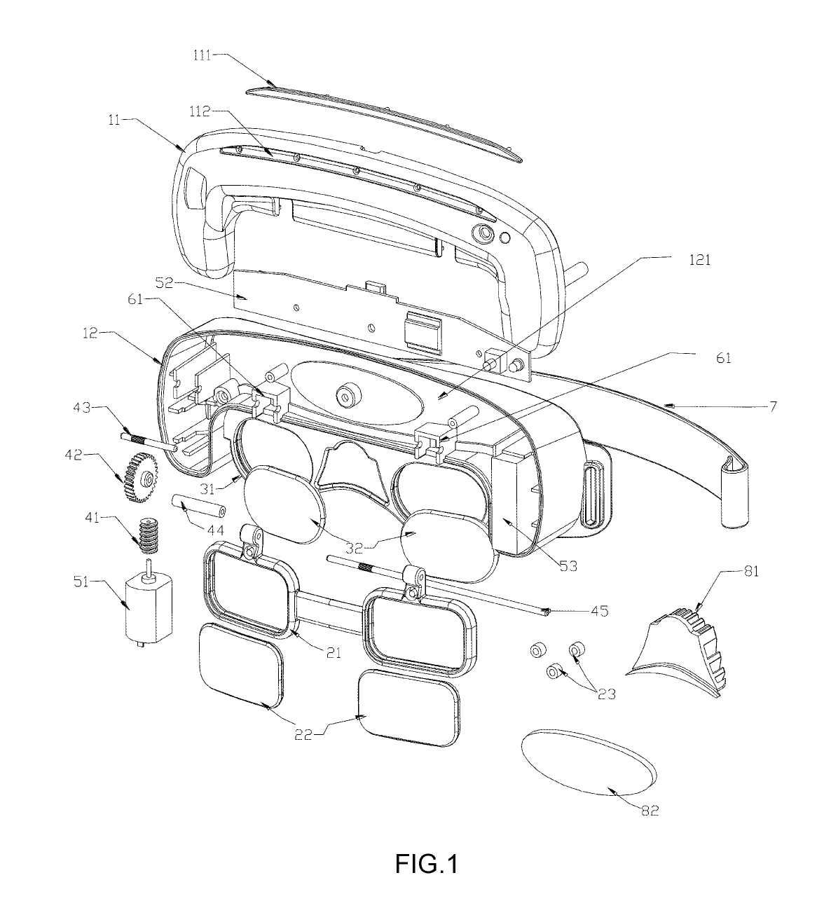

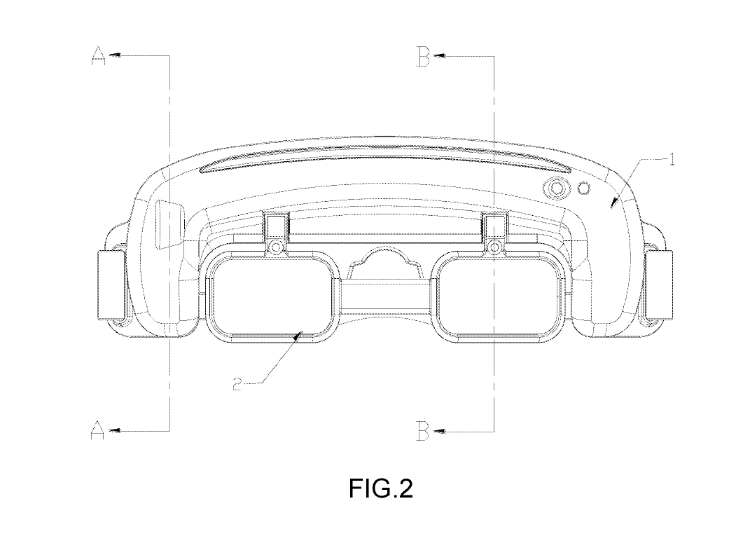

As shown in FIGS. 1 and 2, head wear type automatic flip glasses of the present invention includes a housing 1, front automatic flipping lenses 2, rear fixing lenses 3, a transmission system, a circuit control system and a head fixing member 7. The front automatic flipping lenses 2 are connected with the housing 1 in a flipping way, whereas the rear fixing lenses 3 are in fixed connection with the housing 1. The transmission system and the circuit control system are located in the housing 1.

Optimally, the housing 1 includes a front housing 11 and a rear housing 12. Both of the front housing 11 and the rear housing 12 include a middle-transverse portion and a left portion and a right portion which are located at two ends of the middle-transverse portion. In other words, the front housing 11 includes a front-housing middle-transverse portion and a front-housing right portion and a front-housing left portion which are located on two sides of the front-housing middle-transverse portion, while the rear housing 12 includes a rear-housing middle-transverse portion 121, and a rear-housing left portion and a rear-housing right portion which are located at two ends of the rear-housing middle-transverse portion 121. The housing is overall n-shaped. The front automatic flipping lenses 2 and the rear fixing lenses 3 are located in the n-shaped housing.

Optimally, the front automatic flipping lenses 2 include a front automatic flipping lens frame 21 and two front flipping lenses 22 embedded in the front automatic flipping lens frame 21. The front automatic flipping lens frame 21 includes a left front lens frame, a right front lens frame and a connecting structure between the left and right front lens frames. The connecting structure connects the left and right front lens frames together. When the front automatic flipping lenses 2 are flipping, the left and right front lens frames flip synchronously. The front automatic flipping lens frame 21 can be made from any current materials suitable for manufacturing the flipping lens frame. A cushion 23 is disposed between the front automatic flipping lens frame 21 and the fixing sleeve 62. A silica gel cushion is the optimal choice. The cushion 23 can reduce the vibration of the front automatic flipping lens frame during flipping, and then reduce the shake of the front flipping lenses and keep them stable.

Optimally, the rear fixing lenses 3 include a rear fixing flipping lens frame 31 and two rear flipping lenses 32 embedded in the rear fixing flipping lens frame 31. The upper part of the rear fixing flipping lens frame 31 is fixed with the housing. The rear fixing flipping lens frame 31 can be made from any current available materials suitable for manufacture. Due to features of the flipping lens frame such as strength and hardness, fixing of the lower part of the rear fixing flipping lens frame 31 is not required. Optimally, the rear fixing lenses 3 are fixedly connected with the rear housing 12. In one embodiment, the upper part of the rear fixing flipping lens frame 31 is the lower edge of the rear-housing middle-transverse portion 121. In other words, the upper part of the rear fixing flipping lens frame 31 is directly integrated with the lower part of the rear-housing middle-transverse portion 121. In another embodiment, the upper part of the rear fixing flipping lens frame 31 is fixed at the lower edge of the rear-housing middle-transverse portion 121 by a fastener.

Optimally, the front automatic flipping lenses 2 are connected with the front housing 11 or the rear housing 12 in a flipping way. The housing 1 is provided with corresponding openings at positions in connection with the front automatic flipping lenses 2. That facilitates the front automatic flipping lenses 2′ flipping. The front automatic flipping lenses 2 are connected with the front housing 11 or the rear housing 12 in a flipping way through a flipping structure. The flipping structure includes a fixing clamp 61 and a fixing sleeve 62. The fixing clamp 61 includes two side boards with through-holes. The fixing sleeve 62 has a central hole at the middle part. The fixing sleeve 62 is located between the two side boards of the fixing clamp 61. The central hole corresponds to the through-holes of the side boards. The fixing clamp 61 is located on the front housing 11 or the rear housing 12. And the fixing sleeve 62 is located on the front automatic flipping lens frame 21.

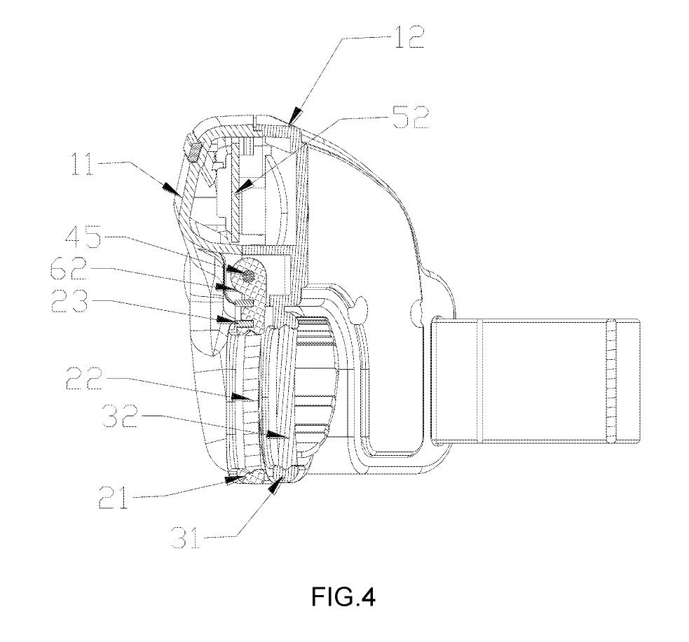

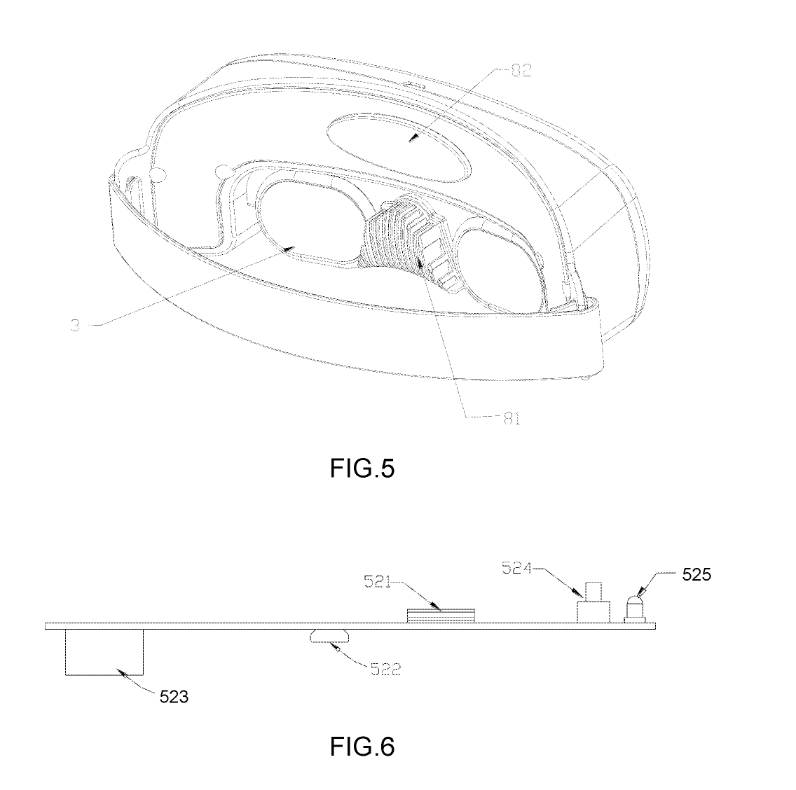

As shown in FIG. 1 and FIG. 4, in one embodiment, the front automatic flipping lenses 2 are connected with the rear-housing middle-transverse portion 121 in a flipping way through the flipping structure. The fixing clamp 61 is located at the lower part of the rear-housing middle-transverse portion 121, and extends beyond the front housing 11. And the fixing sleeve 62 is located above the flipping lens frame of the front automatic flipping lenses 2. In another embodiment, the fixing clamp 61 is disposed at the front-housing middle-transverse portion in the middle cavity. More optimally, there are two flipping structures; the left front lens frame and the right lens frame are respectively provided with a fixing sleeve 62; and the rear-housing middle-transverse portion 121 or the front-housing middle-transverse portion is provided with two fixing clamps 61.

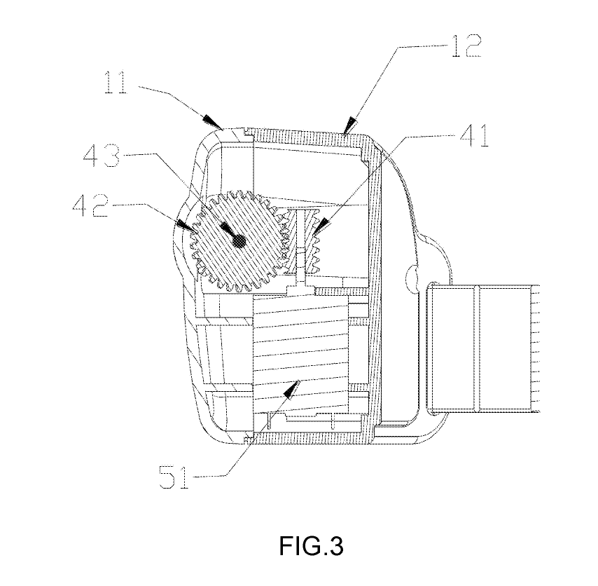

Optimally, as shown in FIG. 1 and FIG. 3, the transmission system is comprised of a worm gear 41, a helical gear 42, a short iron shaft 43, a forced-braking protection structure 44 and a long iron shaft 45; the worm gear 41 is meshed with the helical gear 42; the central hole of the helical gear 42 is connected with one end of the short iron shaft 43; the other end of the short iron shaft 43 is connected with the long iron shaft 45 through the forced-braking protection structure 44; and the long iron shaft 45 is connected with the front automatic flipping lenses 2. Optimally, the forced-braking protection structure 44 has a function of driving the long iron shaft or short iron shaft to slip or idle at the position of the forced-braking protection structure 44, which includes an elastic pipe or a clutch device. More optimally, the elastic pipe is a silica gel pipe or a rubber pipe, and the clutch device is a spring clip. Without the forced-braking protection structure 44, the central hole of the helical gear 42 is connected with one end of an iron shaft, and the iron shaft is connected with the front automatic flipping lenses 2. In use, if a user flips the front automatic flipping lenses 2 with hands, the iron shaft will receive a large resistance when driving the front automatic flipping lenses 2 to flip, and then the motor 51 or the drive gear will be damaged. In one embodiment of the present invention, the forced-braking protection structure 44 is used; the short iron shaft 43 is closely connected with the forced-braking protection structure 44; if the long iron shaft 45 receives a strong resistance when driving the front automatic flipping lenses 2 to flip, the front automatic flipping lenses 2 will not flip, but the long iron shaft will slip or idle at the position of the forced-braking protection structure, while the motor 51 and the drive gear are in normal operation. Thus, damages to the motor 51 and the drive gear can be avoided.

Optimally, the circuit control system is comprised of the motor 51, a circuit control PCB 52 and a battery 53. The shaft of the motor 51 is embedded into the central hole of the worm gear 41. The circuit control PCB 52 controls rotation of the motor 51. The battery 53 supplies power to the circuit control PCB 52. The circuit control PCB 52 controls the operation of the motor 51. The worm gear 41 rotates to drive the helical gear 42 to rotate and to further drive the short iron shaft 43, the forced-braking protection structure 44 and the long iron shaft 45 to rotate, realizing the flip of the front automatic flipping lenses 2.

As shown in FIG. 6, the circuit control PCB 52 is provided with a functional chip 521. The circuit control PCB 52 can be also provided with at least one of a charging plug 522, a motor drive IC 523, a power button 524 and an indicator light 525. The circuit control PCB 52 can also be provided with a charging protection circuit which plays a protection role in the charging process. The functional chip 521 is comprised of a timing module and/or a flipping frequency adjusting module. The timing module is used for controlling the training time, and the flipping frequency adjusting module is used for adjusting the flipping frequency of the front automatic flipping lenses. The charging plug 522 is used for charging the battery 53. The housing is correspondingly provided with an interface in connection with the charging plug 522, and the interface is optimally disposed at the joint of the front housing and the rear housing. In one embodiment, the charging plug 522 is located in the center of the top of the circuit control PCB 52. And the interface is disposed on the top of the housing 1, with one half located on the top of the front housing 11 and the other on the top of the rear housing 12. The two halves together form a complete interface.

The motor drive IC 523 is used for driving the motor 51 to run. The power button 524 is used for switching on and off the circuit control system. The indicator light 525 is used for indicating the working status of the circuit control system. When the power button 524 is on, the circuit control system is in the working status, and the indicator light 525 is electrified and lit; when the power button 524 is off, the circuit control system is not in the working status, and the indicator light loses power supply and turns off. There are openings at positions corresponding to the power button 524 and the indicator light 525 on the housing 1. So the power button 524 and the indicator light 525 are exposed outside the housing for the convenience of operation and observation.

Optimally, the front housing 11 and the rear housing 12 are fixed together through screws, and the cavity formed by the front housing and rear housing is divided into one middle cavity and two lateral cavities. The circuit control PCB 52 is located in the middle cavity, namely between the front-housing middle-transverse portion and the rear-housing middle-transverse portion 121; the transmission system and the motor 51 are located in one lateral cavity, and the battery 53 is located in the other.

Optimally, the degrees of the front automatic flipping lenses 2 and the rear fixing lenses 3 depend on the myopia degree of the wearer and the selected adjustment and training strength/amplitude (X). The algorithm is as follows:

degree of the front automatic flipping lenses=myopia degree of the wearer+(−X),

degree of the rear fixing lenses=myopia degree of the wearer+(+X),

X is any one of 0.5D, 1.0D, 1.5D, 2.0D, 2.5D and 3.0D.

Optimally, the head fixing member 7 is used for fixing the head wear type automatic flip glasses on the head of a person. The head fixing member 7 is located on the left and right side portions of the front housing 11 or rear housing 12, optimally on the left and right portions of the rear housing. In one embodiment of the present invention, the head fixing member 7 may be two tie ropes; the rear-housing left portion and rear-housing right portion are respectively used for fixing one end of one tie rope, and then the untied ends of the ropes are tied together. In that way, the head wear type automatic flip glasses of the present invention is fixed on the head of a person. In another embodiment, the head fixing member 7 is an elastic cord; the rear-housing left portion and rear-housing right portion have a retaining ring respectively. Two bent hooks are provided respectively on both ends of the elastic cord. A person can fix the head wear type automatic flip glasses of the present invention on his/her head by fastening the retaining ring and the bent hook. More optimally, the retaining ring on one side is fixed together with the bent hook, so a person can wear the head wear type automatic flip glasses of the present invention on his/her head firmly or remove the glasses from his/her head easily simply by fastening the retaining ring and the bent hook on the other side together or unfastening the two.

Optimally, the front flipping lenses 22 are pasted with red films for improving visual sensitivity and strengthening amblyopia improvement training. To achieve a beautiful appearance, the front housing 11 is provided with a decorative strip 111, and the decorative strip 111 is disposed in a decorative strip slot 112 at the front-housing middle-transverse portion. In order to improve the comfortableness of using the head wear type automatic flip glasses of the present invention, the rear fixing flipping lens frame is provided with a nose support 81; optimally, the nose support 81 is a silica gel nose support; and the back face of the rear-housing middle-transverse portion is provided with a sponge mat 82. The nose support 81 corresponds to the nose of a person. The sponge mat 82 corresponds to the forehead of a person. The nose support 81 and the sponge mat 82 are made from flexible and elastic materials. That can make users feel more comfortable. Users will not feel tied even if they wear the head wear type automatic flip glasses of the present invention for a long time.

When using, a person wears the head wear type automatic flip glasses of the present invention on the head. The head wear type automatic flip glasses are fixed on the head by using the head fixing member 7. Press the power button 524, and then the front automatic flipping lenses 2 can flip automatically at a certain frequency for a certain time. The user can adjust the flipping frequency and set the service time according to his/her needs. After use, unfasten the head fixing member 7 to remove the head wear type automatic flip glasses of the present invention from the head. The head wear type automatic flip glasses of the present invention can be used for amblyopia treatment and vision improvement training. It can prevent and control myopia which may be caused during amblyopia treatment effectively.

The foregoing descriptions of several embodiments of the invention have been presented for purposes of illustration and description. However, they are not intended to be exhaustive or to limit the invention to the precise forms disclosed. For those practitioners skilled in this field, some variations and modifications can be made on the basis of the concept of the present invention. It should be noted that all those variations and modifications shall fall within the protective scope of the present invention. Therefore, it is intended that the protective scope of the present invention be defined by the following claims and their equivalents.

What is claimed is:

1. Head wear type automatic flip glasses, comprising a housing, front automatic flipping lenses, rear fixing lenses, a transmission system, a circuit control system and a head fixing member, wherein the front automatic flipping lenses are connected with the housing in a flipping way; the rear fixing lenses are in fixed connection with the housing; the front automatic flipping lenses are located in front of the rear fixing lenses; the transmission system and the circuit control system are located in the housing; the head fixing member is fixed on the housing; the transmission system is driven by the circuit control system; the transmission system is used for controlling the front automatic flipping lenses to flip; the housing comprises a front housing and a rear housing; the front automatic flipping lenses are connected with the front housing or the rear housing in a flipping way; the rear fixing lenses are in fixed connection with the rear housing; the front automatic flipping lenses are connected with the front housing or the rear housing in a flipping way through a flipping structure; the flipping structure comprises a fixing clamp and a fixing sleeve; the fixing clamp includes two side boards with through-holes; the fixing sleeve has a central hole at the middle part; the fixing sleeve is located between the two side boards of the fixing clamp; the central hole corresponds to the through-holes of the side boards; the fixing clamp is located on the front housing or the rear housing; and the fixing sleeve is located on the front automatic flipping lens frame.

2. The head wear type automatic flip glasses of claim 1, wherein the rear housing comprises a rear-housing middle-transverse portion; two flipping structures are provided, with one being two fixing sleeves configured on the left and right frame of the front automatic flipping lenses respectively, and the other being two corresponding fixing clamps disposed on the rear-housing middle-transverse portion.

3. The head wear type automatic flip glasses of claim 1, wherein the rear housing comprises a rear-housing middle-transverse portion; the upper part of the flipping lens frame of the rear fixing lenses is the lower edge of the rear-housing middle-transverse portion, or the upper part of the flipping lens frame of the rear fixing lenses is fixed at the lower edge of the rear-housing middle-transverse portion.

4. The head wear type automatic flip glasses of claim 1, wherein the transmission system comprises a worm gear, a helical gear, a short iron shaft, a forced-braking protection structure and a long iron shaft; the worm gear is meshed with the helical gear; the central hole of the helical gear is connected with one end of the short iron shaft, while the other end of the short iron shaft is connected with the long iron shaft through the forced-braking protection structure; the long iron shaft is connected with the flipping structure; and the forced-braking protection structure is an elastic pipe or a clutch device.

5. The head wear type automatic flip glasses of claim 4, wherein the elastic pipe is a silica gel pipe or a rubber pipe, and the clutch device is a spring clip.

6. The head wear type automatic flip glasses of claim 1, wherein the circuit control system comprises a motor, a circuit control PCB and a battery; the motor is connected with the transmission system; the circuit control PCB controls the rotation of the motor; the battery supplies power to the circuit control PCB; the circuit control PCB is provided with a functional chip; and the functional chip comprises a timing module and/or a flipping frequency adjusting module.

7. The head wear type automatic flip glasses of claim 6, wherein the circuit control PCB is configured with at least one of a charging plug, a charging protection circuit, a motor drive IC, a power button and an indicator light.

8. The head wear type automatic flip glasses of claim 1, wherein a hollow cavity formed by the front housing and the rear housing includes a middle cavity and two lateral cavities; the circuit control PCB is disposed in the middle cavity, namely between the front-housing middle-transverse portion and the rear-housing middle-transverse portion; the transmission system and the motor are located in one lateral cavity, and the battery is configured in the other.

9. The head wear type automatic flip glasses of claim 1, wherein the degrees of the front automatic flipping lenses and the rear fixing lenses depend on the myopia degree of the wearer and the selected adjustment training strength/amplitude; the algorithm is as follows:
degree of the front automatic-flipping-lens=myopia degree of the wearer+(−X),
degree of the rear fixing-lens=myopia degree of the wearer+(+X),
X is the selected adjustment training strength/amplitude, which ranges from 0.5D, 1.0D, 1.5D, 2.0D and 2.5D to 3.0D.

10. The head wear type automatic flip glasses of claim 1, wherein the rear fixing flipping lens frame is provided with a nose support; and the back face of the rear housing is provided with a sponge mat.

11. The head wear type automatic flip glasses of claim 1, wherein the head fixing member is an elastic cord or tie ropes.

12. The head wear type automatic flip glasses of claim 11, wherein the left and right sides of the front housing or rear housing are provided with a retaining ring respectively; two bent hooks are provided respectively on both two sides of the elastic cord, with one being fixed at one retaining ring, and the other being in detachable connection with the other retaining ring; two tie ropes are provided, and the left and right sides of the front housing or rear housing respectively fixes one end of one of the tie ropes.

13. The head wear type automatic flip glasses of claim 1, wherein the housing is n-shaped, and the front automatic flipping lenses and the rear fixing lenses are located in the n-shaped housing.
